(19) United States
(12) Patent Application Publication
(10) Pub. No.: US 2014/0047259 A1
(43) Pub. Date: Feb. 13, 2014

(54) Methods and Apparatus for Mobile Device Power Management Using Accelerometer Data

(71) Applicant: mCube, Incorporated, (US)

(72) Inventors: Jobe Price, North Liberty, IA (US); Joe Kelly, Center Point, IA (US)

(73) Assignee: mCube, Incorporated, San Jose, CA (US)

(21) Appl. No.: 13/759,027

(22) Filed: Feb. 4, 2013

Related U.S. Application Data
(60) Provisional application No. 61/595,012, filed on Feb. 3, 2012.

(51) Int. Cl. G06F 1/32

(52) U.S. Cl. CPC G06F 1/3206; G06F 1/3287
USPC 713/324; 713/320

(57) ABSTRACT

A computer-implemented method for power management in a portable device includes receiving sensor information from a sensor in the portable device, associating the sensor information with one of a plurality of states of the portable device, and reducing electrical power consumption in one or more parts in the portable device according to the associated state of the portable device. In some embodiments, the method also includes collecting, from the accelerometer in the portable device, electrical signals associated with a plurality of known motion states of the portable device, and analyzing the collected electrical signals. The method also includes identifying attributes of the electrical signal with the known motion states of the portable device.

### CROSS-REFERENCES TO RELATED APPLICATIONS

This application claims priority to U.S. Provisional Patent Application No. 61/595,012, filed Feb. 3, 2012, commonly owned, whose content is incorporated by reference herein for all purposes.

### BACKGROUND OF THE INVENTION

The present invention relates to portable computing devices. More specifically, the present invention relates to methods for power management in a portable computing device based on sensed data from a MEMS (MicoElectroMechanical system) based device.

Currently, more and more portable computing devices are becoming available to the average user/consumer. Such devices may include reader-type devices (e.g. Kindle, Nook), tablet-type devices (e.g. iPad, GalaxyTab), phone-type devices (e.g. iPhone, GalaxyS2), or the like. Many of these devices now include specialized hardware (e.g. MEMS devices) that can sense physical properties or physical inputs to the device. Such specialized hardware typically includes 3-axis accelerometers, a gyroscope, and a compass that are provided on separate electronic packages.

In today's wireless handset market, inertial applications such as gesture recognition, haptics, and indoor navigation have become mainstays. All of these types of applications are dependent on MEMS devices, namely the gyroscope, magnetometer, and accelerometer, etc. Many useful and popular software applications have been written for portable computing devices that use information from the specialized hardware. In one example in the operating system, by turning a computing device on its side, the image displayed on a display will rotate to match the new orientation of the computing device. In one example in an augmented reality application, by moving the portable computing device in three-dimensional space, information presented to the user will vary and depend upon the compass orientation of the device as well as the gyroscopic orientation of the device.

One problem associated with mobile devices is that current mobile devices have limited battery life. Therefore, the conservation of power is a critical system component in the cell phone industry

In light of the above, what is desired are methods and apparatus that address the issues described above.

### BRIEF SUMMARY OF THE INVENTION

The present invention relates to portable computing devices. More specifically, the present invention relates to methods for power management in a portable computing device based on sensed data from a MEMS device.

In some embodiments of the present invention, a portable device programmed to reduce power consumption includes a housing comprising a display portion and a body portion, a sensor disposed within the housing and is configured to sense an acceleration of the portable device, and a processor coupled to the display portion and to the sensor and disposed within the housing. The processor is configured to receive sensor information from a sensor in the portable device, and reduce electrical power consumption in one or more parts in the portable device according to the state of the portable device associated with the received sensor information. In some embodiments, the sensor in the portable device includes a MEMS (MicroElectroMechanical system) accelerometer integrated with CMOS (complementary metal oxide semiconductor) circuitry in a single integrated circuit (IC).

According to some embodiments of the present invention, a computer-implemented method for power management in a portable device includes receiving sensor information from a sensor in the portable device, associating the sensor information with one of a plurality of states of the portable device, and reducing electrical power consumption in one or more parts in the portable device according to the associated state of the portable device. In some embodiments, the method also includes collecting, from the accelerometer in the portable device, electrical signals associated with a plurality of known motion states of the portable device, and analyzing the collected electrical signals. The method also includes identifying attributes of the electrical signal with the known motion states of the portable device.

According to another embodiment of the present invention, a computer program product includes computer-readable code resident on a non-transitory tangible media for programming a computing system in a portable device to reduce power consumption in the portable device. the computer program product includes code that programs the computing system to receive sensor information from a sensor in the portable device, code that programs the computing system to associate the sensor information with one of a plurality of states of the portable device, and code that programs the computing system to reduce electrical power consumption in one or more parts in the portable device according to the associated state of the portable device. In some embodiments, the computer program product also includes code that programs the computing system to collect, from the accelerometer in the portable device, electrical signals associated with a plurality of known motion states of the portable device, code that programs the computing system to analyze the collected electrical signals, and code that programs the computing system to identify attributes of the electrical signal with the known motion states of the portable device.

### BRIEF DESCRIPTION OF THE DRAWINGS

In order to more fully understand the present invention, reference is made to the accompanying drawings. Understanding that these drawings are not to be considered limitations in the scope of the invention, the presently described embodiments and the presently understood best mode of the invention are described with additional detail through use of the accompanying drawings in which:

FIG. 1 illustrates a diagram of acceleration data versus time recorded in a portable device according to various embodiments of the present invention;

FIG. 2 illustrates another diagram of acceleration data versus time recorded in a portable device according to various embodiments of the present invention;

FIGS. 3A-3C illustrate diagrams showing different contexts or states of a portable device according to various embodiments of the present invention;

FIG. 4 illustrates a flow chart of a process according to various embodiments of the present invention; and

FIG. 5 illustrates a functional block diagram of various embodiments of the present invention.

### DETAILED DESCRIPTION OF THE INVENTION

The conservation of power is a critical system component in the portable device industry. A MEMS sensor allows the system to indicate the context or position of a portable device, e.g. a mobile phone, and how it is being used. In embodiments of the present invention, when these contexts are indicated, different power control schemes are utilized by the cell phone in order to extend battery life and optimize power.

According to embodiments of the invention, one way to indicate movement in a cell phone is with a motion sensor and software. Motion sensors can also indicate stationary conditions. In portable devices, accelerometers are often used as motion sensors. An accelerometer is an electromechanical device that will measure acceleration forces. These forces may be static, like the constant force of gravity pulling at your feet, or they could be dynamic, caused by moving or vibrating the accelerometer. By measuring the amount of static acceleration due to gravity, the angle the device is tilted at with respect to the earth can be determined. By sensing the amount of dynamic acceleration, the way the device is moving can be analyzed. In embodiments of the invention, when certain contexts are entered or exited, the cell phone can turn on or off the power in different components in order to save power.

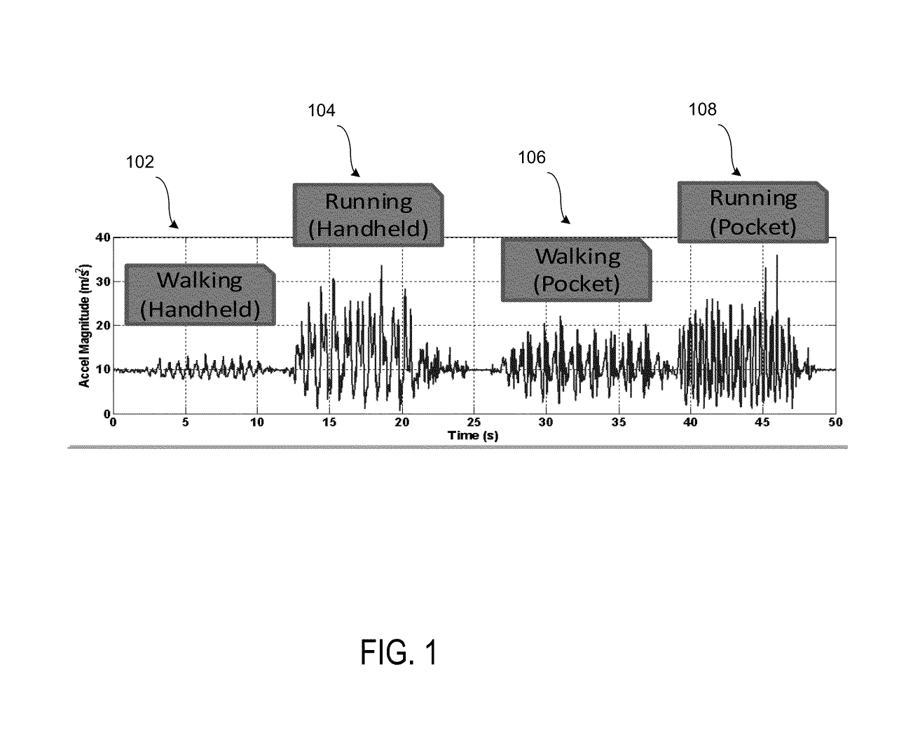

FIG. 1 illustrates a diagram of acceleration data versus time recorded in a portable device according to various embodiments of the present invention. The data in FIG. 1 is an example of different sets of accelerometer signatures, which indicate different acceleration data detected when the portable device is held by a user who is walking or running, and acceleration data detected when a user is walking or running with the portable device being held by the user or being stowed in the user's pocket. For example, FIG. 1 shows acceleration data from a motion sensor when the portable device is held by a user who is walking 102, when the portable device is held by a user who is running 104, when the portable device is in the pocket of a user who is walking 106, or when the portable device is in the pocket of a user who is running 108.

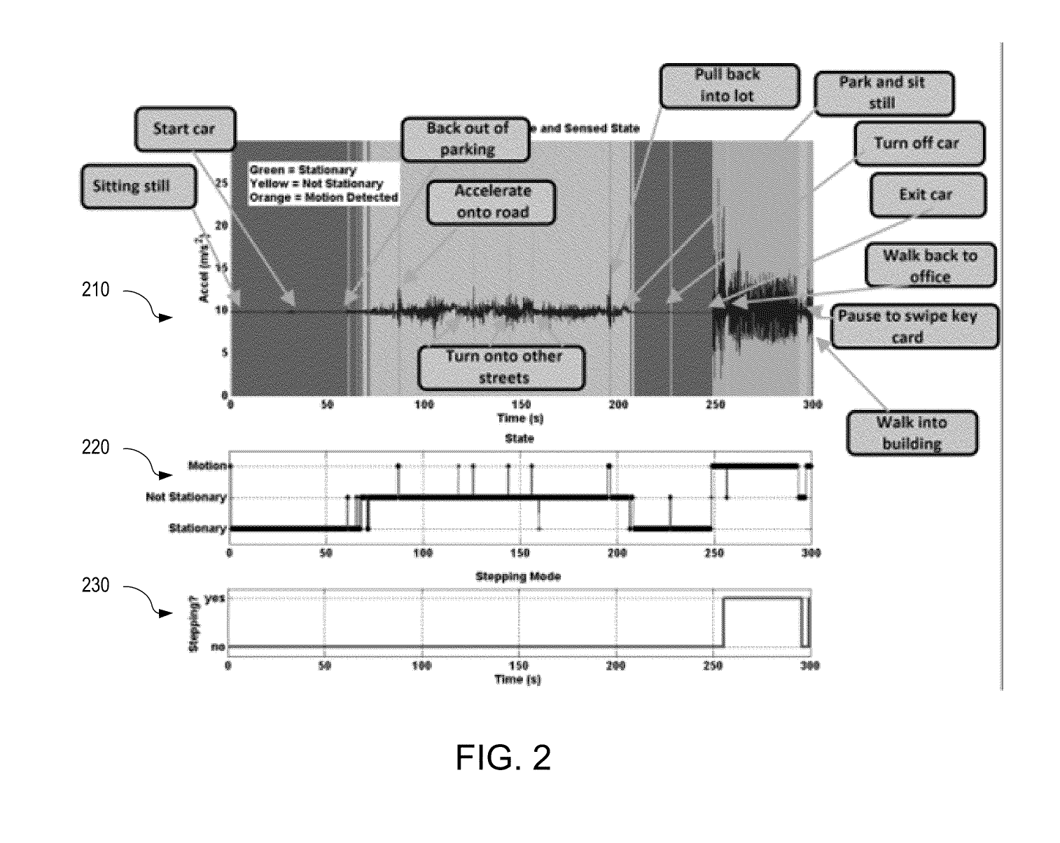

FIG. 2 illustrates another diagram of acceleration data versus time recorded in a portable device according to various embodiments of the present invention. FIG. 2 is an example of different cell phone contexts in a real world scenario. This particular example includes acceleration data 210 detected of a user leaving a building, sitting in the car, starting the car, driving, returning to office, parking car, exiting and walking back into the office. Embodiments of the invention include collecting and analyzing accelerometer data, and associating the accelerometer data from the portable device with real world scenario. The accelerometer data is a useful indicator of what the user is doing and when the user is stationary or in various motions. For example, FIG. 2 also shows that acceleration data can be analyzed to determine the state of motion 220 of the user, stationary, not stationary, or in motion. Further, the signature of acceleration data can also be used to determine that the user is making a stepping motion 230.

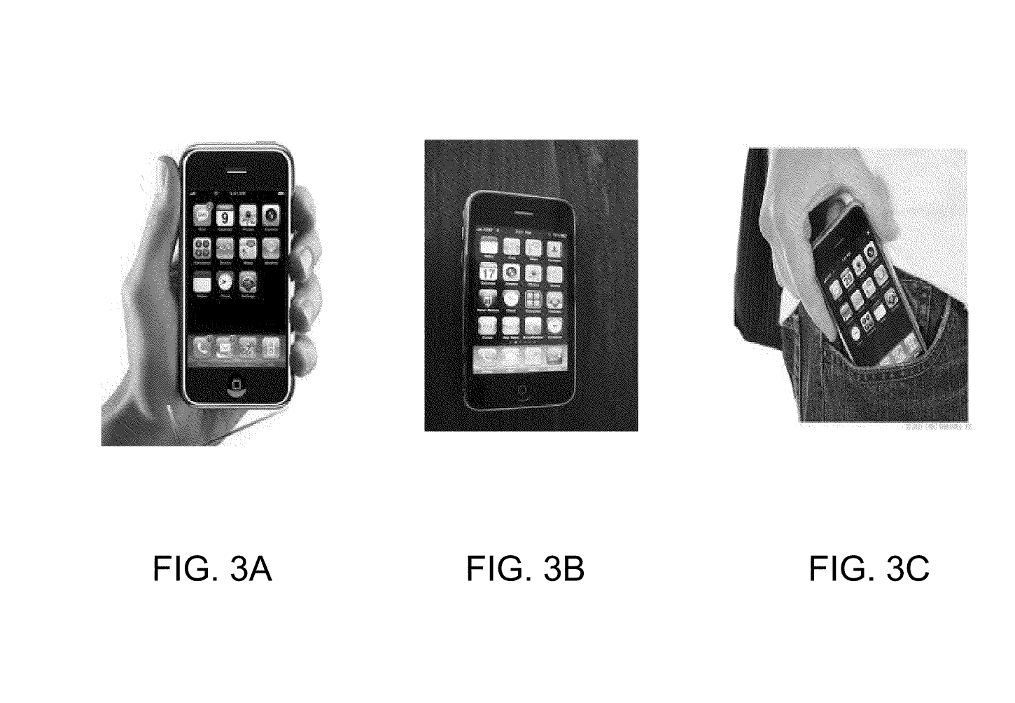

FIGS. 3A-3C illustrate different contexts or states of a portable device according to various embodiments of the present invention. FIG. 3A shows a cell phone being held in the hand of a user. FIG. 3B shows a cell phone being stationary on a table top. In FIG. 3C, the cell phone is in a user's pocket. In embodiments of the invention, sensor information can be used to indicate cell phone contexts and use portable device context information in power management. For example, a cell phone can be put in sleep mode, or power down, or enable portions of the cell phone. For example, when the phone enters a stationary condition, certain portions of the phone can be put to sleep mode. When the phone senses movement, it can wake up these components. Further, when the sensor data indicates that the cell phone is in a pocket, certain parts of the phone can be disabled, for example, the proximity sensor can be disabled. In another example, the backlight can be disabled.

Embodiments of the invention include collecting and analyzing accelerometer data, and associate the accelerometer data from the portable device with real world scenario. In embodiments of the invention, an accelerometer can be used along with filter software to identify different phone contexts. This information is used in cell phone power management to reduce power consumption.

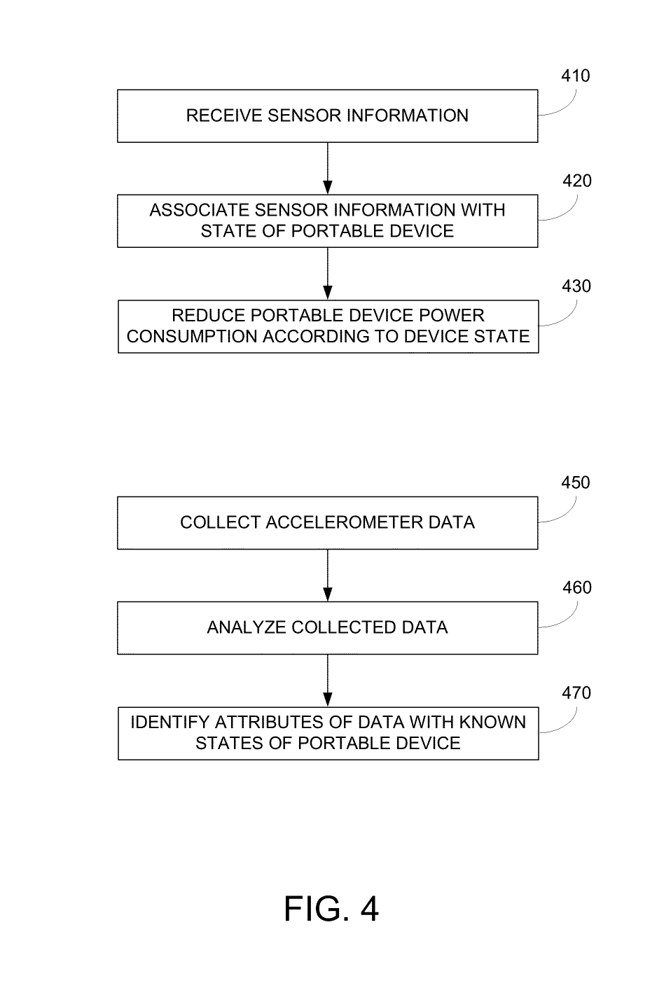

FIG. 4 illustrates flow charts of processes according to various embodiments of the present invention. The flow charts in FIG. 4 illustrate a computer-implemented method for power management in a portable device programmed to perform the method. The method includes:
Step 410—receiving sensor information from a sensor in the portable device;
Step 420—associating the sensor information with one of a plurality of states of the portable device; and
Step 430—reducing electrical power consumption in one or more parts in the portable device according to the associated state of the portable device.

The sensor referred to in the above method includes a motion sensor. The sensor can also include very low power three-axis sensors (linear, gyro or magnetic); ultra-low jitter three-axis sensors (linear, gyro or magnetic); low cost six-axis motion sensor (combination of linear, gyro, and/or magnetic); ten-axis sensors (linear, gyro, magnetic, pressure); and various combinations thereof. In specific embodiments, the sensor in the portable device includes a MEMS (MicroElectroMechanical system) accelerometer integrated with CMOS (complementary metal oxide semiconductor) circuitry in a single integrated circuit (IC).

The above method also includes,
Step 450—collecting, from the accelerometer in the portable device, electrical signals associated with a plurality of known motion states of the portable device;
Step 460—analyzing the collected electrical signals; and
Step 470—identifying attributes of the electrical signal with the known motion states of the portable device.

In a specific embodiment, the plurality of known motion states of the portable device includes a first state wherein the portable device being held in the hand of a user and a second state wherein the portable device being stowed in a pocket of a user. In another embodiment, the plurality of known motion states of the portable device includes a third state wherein the portable device is in the possession of a user who is walking and a fourth state wherein the portable device is being in the possession of a user who is running. In yet another embodiment, the plurality of known motion states of the portable device includes a fifth state wherein the user is stationary, a sixth state wherein the user is not stationary, and a seventh state wherein the user is in motion.

In another embodiment of the method, reducing electrical power consumption in the portable device includes turning off power in a proximity sensor in the portable device. In still another embodiment, reducing electrical power consumption in the portable device comprises turning off power for a backlight in the portable device.

In some embodiments of the present invention, a portable device programmed to reduce power consumption includes a housing comprising a display portion and a body portion, a sensor disposed within the housing and is configured to sense an acceleration of the portable device, and a processor coupled to the display portion and to the sensor and disposed within the housing. The processor is configured to receive sensor information from a sensor in the portable device, associate the sensor information with one of a plurality of states of the portable device, and reduce electrical power consumption in one or more parts in the portable device according to the associated state of the portable device. In some embodiments, the sensor in the portable device includes a MEMS (MicroElectroMechanical system) accelerometer integrated with CMOS (complementary metal oxide semiconductor) circuitry in a single integrated circuit (IC).

In some embodiments of the portable device, the processor is further configured to collect, from the accelerometer in the portable device, electrical signals associated with a plurality of known motion states of the portable device, analyze the collected electrical signals, and identify attributes of the electrical signal with the known motion states of the portable device. In a specific embodiment, the plurality of known motion states of the portable device includes the portable device being held in the hand of a user or the portable device being stowed in a pocket of a user. In another embodiment, the plurality of known motion states of the portable device includes the following states of a user: the user is stationary, the user is not stationary, or the user is in motion.

In a specific embodiment of the portable device, the processor is configured to reduce electrical power consumption in the portable device by turning off power for a proximity sensor in the portable device. In another embodiment, the processor is configured to reduce electrical power consumption in the portable device by turning off power for a backlight in the portable device.

According to an alternative embodiment of the present invention, a computer program product includes computer-readable code resident on a non-transitory tangible media for programming a computing system in a portable device to reduce power consumption in the portable device. The computer program product includes code that programs the computing system to receive sensor information from a sensor in the portable device, code that programs the computing system to associate the sensor information with one of a plurality of states of the portable device, and code that programs the computing system to reduce electrical power consumption in one or more parts in the portable device according to the associated state of the portable device.

In some embodiments, the above computer program product also includes code that programs the computing system to collect, from the accelerometer in the portable device, electrical signals associated with a plurality of known motion states of the portable device, code that programs the computing system to analyze the collected electrical signals, and code that programs the computing system to identify attributes of the electrical signal with the known motion states of the portable device. In a specific embodiment, the plurality of known motion states of the portable device includes the portable device being held in the hand of a user or the portable device being stowed in a pocket of a user. In a specific embodiment of the computer program product, the sensor in the portable device comprises a MEMS (MicroElectroMechanical system) accelerometer integrated with CMOS (complementary metal oxide semiconductor) circuitry in a single integrated circuit (IC).

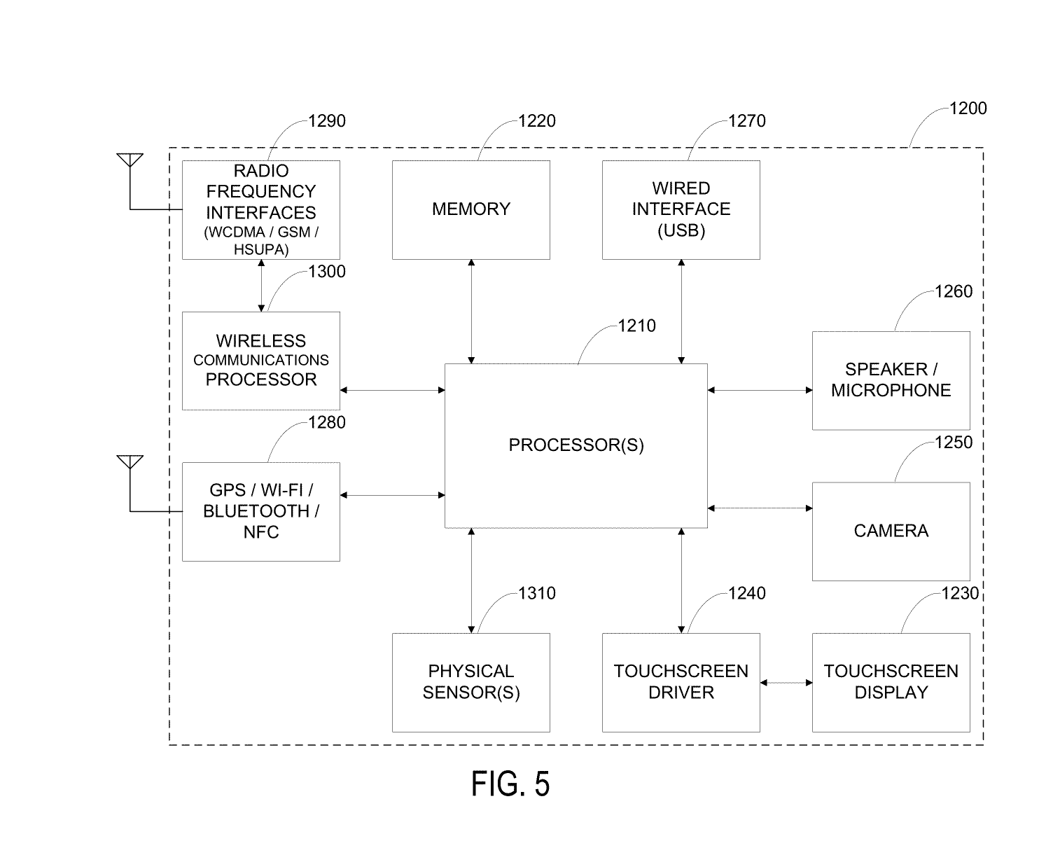

FIG. 5 illustrates a functional block diagram of various embodiments of the present invention. In FIG. 5, a computing device 1200 typically includes an applications processor 1210, memory 1220, a touch screen display 1230 and driver 1240, an image acquisition device 1250, audio input/output devices 1260, and the like. Additional communications from and to computing device are typically provided by via a wired interface 1270, a GPS/Wi-Fi/Bluetooth interface 1280, RF interfaces 1290 and driver 1300, and the like. Also included in various embodiments are physical sensors 1310.

In various embodiments, computing device 1200 may be a hand-held computing device (e.g. Apple iPad, Apple iTouch, Dell Mini slate, Lenovo Skylight/IdeaPad, Asus EEE series, Microsoft Courier, Samsung Galaxy Tab, Android Tablet), a portable telephone (e.g. Apple iPhone, Motorola Droid series, Google Nexus S, HTC Sensation, Samsung Galaxy S series, Palm Pre series, Nokia Lumina series), a portable computer (e.g. netbook, laptop, ultrabook), a media player (e.g. Microsoft Zune, Apple iPod), a reading device (e.g. Amazon Kindle Fire, Barnes and Noble Nook), or the like.

Typically, computing device 1200 may include one or more processors 1210. Such processors 1210 may also be termed application processors, and may include a processor core, a video/graphics core, and other cores. Processors 1210 may be a processor from Apple (A4/A5), Intel (Atom), NVidia (Tegra 2, 3), Marvell (Armada), Qualcomm (Snapdragon), Samsung, TI (OMAP), or the like. In various embodiments, the processor core may be an Intel processor, an ARM Holdings processor such as the Cortex-A, -M, -R or ARM series processors, or the like. Further, in various embodiments, the video/graphics core may be an Imagination Technologies processor PowerVR-SGX, -MBX, -VGX graphics, an Nvidia graphics processor (e.g. GeForce), or the like. Other processing capability may include audio processors, interface controllers, and the like. It is contemplated that other existing and/or later-developed processors may be used in various embodiments of the present invention.

In various embodiments, memory 1220 may include different types of memory (including memory controllers), such as flash memory (e.g. NOR, NAND), pseudo SRAM, DDR SDRAM, or the like. Memory 1220 may be fixed within computing device 1200 or removable (e.g. SD, SDHC, MMC, MINI SD, MICRO SD, CF, SIM). The above are examples of computer readable tangible media that may be used to store embodiments of the present invention, such as computer-executable software code (e.g. firmware, application programs), application data, operating system data or the like. It is contemplated that other existing and/or later-developed memory and memory technology may be used in various embodiments of the present invention.

In various embodiments, touch screen display 1230 and driver 1240 may be based upon a variety of later-developed or current touch screen technology including resistive displays, capacitive displays, optical sensor displays, electromagnetic resonance, or the like. Additionally, touch screen display 1230 may include single touch or multiple-touch sensing capability. Any later-developed or conventional output display technology may be used for the output display, such as TFT-LCD, OLED, Plasma, trans-reflective (Pixel Qi), electronic ink (e.g. electrophoretic, electrowetting, interferometric modulating). In various embodiments, the resolution of such displays and the resolution of such touch sensors may be set based upon engineering or non-engineering factors (e.g. sales, marketing). In some embodiments of the present invention, a display output port, such as an HDMI-based port or DVI-based port may also be included.

In some embodiments of the present invention, image capture device 1250 may include a sensor, driver, lens and the like. The sensor may be based upon any later-developed or convention sensor technology, such as CMOS, CCD, or the like. In various embodiments of the present invention, image recognition software programs are provided to process the image data. For example, such software may provide functionality such as: facial recognition, head tracking, camera parameter control, or the like.

In various embodiments, audio input/output 1260 may include conventional microphone(s)/speakers. In some embodiments of the present invention, three-wire or four-wire audio connector ports are included to enable the user to use an external audio device such as external speakers, headphones or combination headphone/microphones. In various embodiments, voice processing and/or recognition software may be provided to applications processor 1210 to enable the user to operate computing device 1200 by stating voice commands. Additionally, a speech engine may be provided in various embodiments to enable computing device 1200 to provide audio status messages, audio response messages, or the like.

In various embodiments, wired interface 1270 may be used to provide data transfers between computing device 1200 and an external source, such as a computer, a remote server, a storage network, another computing device 1200, or the like. Such data may include application data, operating system data, firmware, or the like. Embodiments may include any later-developed or conventional physical interface/protocol, such as: USB 2.0, 3.0, micro USB, mini USB, Firewire, Apple iPod connector, Ethernet, POTS, or the like. Additionally, software that enables communications over such networks is typically provided.

In various embodiments, a wireless interface 1280 may also be provided to provide wireless data transfers between computing device 1200 and external sources, such as computers, storage networks, headphones, microphones, cameras, or the like. As illustrated in FIG. 5, wireless protocols may include Wi-Fi (e.g. IEEE 802.11a/b/g/n, WiMax), Bluetooth, IR, near field communication (NFC), ZigBee and the like.

GPS receiving capability may also be included in various embodiments of the present invention, however is not required. As illustrated in FIG. 5, GPS functionality is included as part of wireless interface 1280 merely for sake of convenience, although in implementation, such functionality is currently performed by circuitry that is distinct from the Wi-Fi circuitry and distinct from the Bluetooth circuitry.

Additional wireless communications may be provided via RF interfaces 1290 and drivers 300 in various embodiments. In various embodiments, RF interfaces 1290 may support any future-developed or conventional radio frequency communications protocol, such as CDMA-based protocols (e.g. WCDMA), GSM-based protocols, HSUPA-based protocols, or the like. In the embodiments illustrated, driver 300 is illustrated as being distinct from applications processor 1210. However, in some embodiments, these functionalities are provided upon a single IC package, for example the Marvel PXA330 processor, and the like. It is contemplated that some embodiments of computing device 1200 need not include the RF functionality provided by RF interface 1290 and driver 1300.

FIG. 5 also illustrates computing device 1200 to include physical sensors 310. In various embodiments of the present invention, physical sensors 310 are multi-axis Micro-Electro-Mechanical Systems (MEMS) based devices being developed by M-cube, the assignee of the present patent application. Physical sensors 310 developed by M-cube currently include very low power three-axis sensors (linear, gyro or magnetic); ultra-low jitter three-axis sensors (linear, gyro or magnetic); low cost six-axis motion sensor (combination of linear, gyro, and/or magnetic); ten-axis sensors (linear, gyro, magnetic, pressure); and various combinations thereof.

Various embodiments may include an accelerometer with a reduced substrate displacement bias, as described above. Accordingly, using such embodiments, computing device 1200 is expected to have a lower sensitivity to temperature variations, lower sensitivity to production/assembly forces imparted upon to an accelerometer, faster calibration times, lower production costs, and the like.

As described in the patent applications referenced above, various embodiments of physical sensors 310 are manufactured using a foundry-compatible process. As explained in such applications, because the process for manufacturing such physical sensors can be performed on a standard CMOS fabrication facility, it is expected that there will be a broader adoption of such components into computing device 1200. In other embodiments of the present invention, conventional physical sensors 1310 from Bosch, ST Microelectrnics, Analog Devices, Kionix or the like may be used.

In various embodiments, any number of future developed or current operating systems may be supported, such as iPhone OS (e.g. iOS), WindowsMobile (e.g. 7, 8), Google Android (e.g. 3.x, 4.x), Symbian, or the like. In various embodiments of the present invention, the operating system may be a multi-threaded multi-tasking operating system. Accordingly, inputs and/or outputs from and to touch screen display 1230 and driver 1240 and inputs/or outputs to physical sensors 310 may be processed in parallel processing threads. In other embodiments, such events or outputs may be processed serially, or the like. Inputs and outputs from other functional blocks may also be processed in parallel or serially, in other embodiments of the present invention, such as image acquisition device 1250 and physical sensors 1310.

FIG. 5 is representative of one computing device 1200 capable of embodying the present invention. For example, the power management method described above can be implemented in computing device 1200. However, it will be readily apparent to one of ordinary skill in the art that many other hardware and software configurations are suitable for use with the present invention. Embodiments of the present invention may include at least some but need not include all of the functional blocks illustrated in FIG. 5. For example, in various embodiments, computing device 1200 may lack image acquisition unit 1250, or RF interface 1290 and/or driver 1300, or GPS capability, or the like. Additional functions may also be added to various embodiments of computing device 1200, such as a physical keyboard, an additional image acquisition device, a trackball or trackpad, a joystick, or the like. Further, it should be understood that multiple functional blocks may be embodied into a single physical package or device, and various functional blocks may be divided and be performed among separate physical packages or devices.

In light of the present patent disclosure, one of ordinary skill in the art will recognize many other operations may be performed, as embodiments of the present invention. For example, embodiments of (value-added) services may include personal health assistants, targeted discount coupons, or the like.

In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A computer-implemented method for power management in a portable device programmed to perform the method, the method comprising:
receiving sensor information from a sensor in the portable device;
associating the sensor information with one of a plurality of states of the portable device; and
reducing electrical power consumption in one or more parts in the portable device according to the associated state of the portable device.

2. The computer-implemented method of claim 1, wherein the sensor in the portable device comprises a motion sensor.

3. The computer-implemented method of claim 2, wherein the sensor in the portable device comprises a MEMS (MicroElectroMechanical system) accelerometer integrated with CMOS (complementary metal oxide semiconductor) circuitry in a single integrated circuit (IC).

4. The computer-implemented method of claim 3, further comprising:
collecting, from the accelerometer in the portable device, electrical signals associated with a plurality of known motion states of the portable device;
analyzing the collected electrical signals; and
identifying attributes of the electrical signal with the known motion states of the portable device.

5. The computer-implemented method of claim 4 wherein the plurality of known motion states of the portable device comprises:
the portable device being held in the hand of a user; and
the portable device being stowed in a pocket of a user.

6. The computer-implemented method of claim 4 wherein the plurality of known motion states of the portable device comprises:
being in the possession of a user who is walking; and
being in the possession of a user who is running.

7. The computer-implemented method of claim 4 wherein the plurality of known motion states of the portable device comprises the following states of a user
the user is stationary;
the user is not stationary; and
the user is in motion.

8. The computer-implemented method of claim 1 wherein reducing electrical power consumption in the portable device comprises turning off power in a proximity sensor in the portable device.

9. The computer-implemented method of claim 1 wherein reducing electrical power consumption in the portable device comprises turning off power for a backlight in the portable device.

10. A portable device programmed to reduce power consumption, wherein the portable device comprises:
a sensor configured to sense an acceleration of the portable device;
a processor coupled to the sensor and disposed within the housing;
wherein the processor is configured to:
receive sensor information from a sensor in the portable device; and
reduce electrical power consumption in one or more parts in the portable device according to the received sensor information.

11. The portable device of claim 10 wherein the sensor in the portable device comprises a MEMS (MicroElectroMechanical system) accelerometer integrated with CMOS (complementary metal oxide semiconductor) circuitry in a single integrated circuit (IC).

12. The portable device of claim 11, wherein the processor is further configured to:
collect, from the accelerometer in the portable device, electrical signals associated with a plurality of known motion states of the portable device;
analyze the collected electrical signals; and
identify attributes of the electrical signal with the known motion states of the portable device.

13. The portable device of claim 12, wherein the plurality of known motion states of the portable device comprises:
the portable device being held in the hand of a user; and
the portable device being stowed in a pocket of a user.

14. The portable device of claim 12, wherein the plurality of known motion states of the portable device comprises the following states of a user:
the user is stationary;
the user is not stationary; and
the user is in motion.

15. The portable device of claim 10, wherein the processor is configured to reduce electrical power consumption in the portable device by turning off power for a proximity sensor in the portable device.

16. The portable device of claim 10, wherein the processor is configured to reduce electrical power consumption in the portable device by turning off power for a backlight in the portable device.

17. A computer program product comprising computer-readable code resident on a non-transitory tangible media for programming a computing system in a portable device to reduce power consumption in the portable device, the computer program product comprises:
code that programs the computing system to receive sensor information from a sensor in the portable device;
code that programs the computing system to associate the sensor information with one of a plurality of states of the portable device; and
code that programs the computing system to reduce electrical power consumption in one or more parts in the portable device according to the associated state of the portable device.

18. The computer program product of claim 17, wherein the sensor in the portable device comprises a MEMS (MicroElectroMechanical system) accelerometer integrated with CMOS (complementary metal oxide semiconductor) circuitry in a single integrated circuit (IC).

19. The computer program product of claim 18, wherein the computer program product further comprises:
code that programs the computing system to collect, from the accelerometer in the portable device, electrical signals associated with a plurality of known motion states of the portable device;
code that programs the computing system to analyze the collected electrical signals; and
code that programs the computing system to identify attributes of the electrical signal with the known motion states of the portable device.

20. The computer program product of claim 19, wherein the plurality of known motion states of the portable device comprises:
the portable device being held in the hand of a user; and
the portable device being stowed in a pocket of a user.
